(19) United States
(12) Patent Application Publication
(10) Pub. No.: US 2005/0248951 A1
(43) Pub. Date: Nov. 10, 2005

(54) Slip-resistant apparatus and method

(76) Inventors: Douglas W. Hagen, Coarsegold, CA (US); Patrick Case, Fresno, CA (US); Christopher Alder, Geneva, IL (US)

Correspondence Address: KOPPEL, JACOBS, PATRICK & HEYBL, 555 ST. CHARLES DRIVE, SUITE 107, THOUSAND OAKS, CA, 91360, US

(21) Appl. No.: 11/090,744

(22) Filed: Mar. 24, 2005

Related U.S. Application Data
(60) Provisional application No. 60/556,627, filed on Mar. 26, 2004.

(51) Int. Cl. B32B 17/06; B05D 1/12

(52) U.S. Cl. 362/382; 427/180; 428/432

(57) ABSTRACT

A slip-resistant apparatus includes a transparent plate, frit regions coupled to a surface of the plate, and grit granules partially embedded in the frit regions, so that the coefficient of friction of the plate is increased.

This application claims the benefit of Provisional Application Ser. No. 60/556,627, filed Mar. 26, 2004.

### BACKGROUND OF THE INVENTION

1. Field of the Invention

This invention relates to slip-resistant surfaces, and more particularly to slip-resistant transparent plates.

2. Description of the Related Art

The design of slip-resistant surfaces is increasingly important as various government agencies have set legal and enforceable standards for slip-resistance on pedestrian walkways. Increasing slip-resistance on those walkways is also important to reduce slip and fall accidents and is effected by walkway material and finish, footwear material, surface contaminants, and pedestrian gate dynamics. One such measure of slip resistance on a surface is its coefficient of friction, defined as the frictional force opposing the sliding motion of an object divided by the force perpendicular to the surface. A slip-resistant surface may be required when designing for pedestrian walkways that may be exposed to wet or oily conditions that tend to reduce the surface's coefficient of friction.

One such slip-resistant surface and method is taught by Joseph R. Tippmann in U.S. Pat. No. 6,468,585 (the “'585 patent”). In the '585 patent, a method of providing a textured surface to a floor includes the steps of applying a layer of resinous material over the surface of the floor, placing a single layer of sand on the resinous material, and applying a layer of clear epoxy resin over the layer of sand. In U.S. Pat. No. 6,632,506, Terrand B. Grall teaches the use of high-visibility traction tape that combines a high-friction slip-resistant surface for traction and a reflective surface for high-visibility.

Exterior lighting systems typically employ in-ground lighting fixtures with transparent lenses that may form part of a pedestrian walkway. The light source is typically below ground level with light from the light source emitting through a lens to illuminate an above ground landscape or architectural feature. In many applications the lens is at ground level and in an area of pedestrian and/or vehicle traffic. Such transparent lenses are designed to be robust enough to withstand the weight of a pedestrian and/or vehicle, but may become subject to slip and fall accidents when exposed to wet or oily conditions. The '506 and '585 patents, while appropriate for non-optical applications, may be less advantageous when used on transparent surfaces.

### SUMMARY OF THE INVENTION

A slip-resistant apparatus is disclosed for use in transparent surface applications. It has a transparent plate, a plurality of frit regions coupled to a surface of the plate and a plurality of grit granules partially embedded in the plurality of frit regions to increase the surface's coefficient of friction.

In one embodiment of the invention, an in-grade lighting fixture has a housing, a lens coupled to one end of the housing, a plurality frit regions coupled to the surface and a plurality of grit granules partially embedded in the plurality of frit regions to increase the coefficient friction for the surface from what would otherwise exist without the grit granules.

A method of manufacturing the slip-resistant lens includes, forming a pattern of enamel regions having embedded frit onto a transparent surface, introducing a plurality of grit granules onto the enamel regions and melting and cooling the frit so that the grit granules become partially embedded in the frit.

These and other features and advantages of the invention will be apparent to those skilled in the art from the following detailed description of preferred embodiments, taken together with the accompanying drawings.

### BRIEF DESCRIPTION OF THE DRAWINGS

The components in the figures are not necessarily to scale, emphasis instead being placed on illustrating the principles of the invention. Like reference numerals designate corresponding parts throughout the different views.

FIG. 1 is a plan view of a lens in accordance with one embodiment of the invention;

FIGS. 2a and 2b are side views of two embodiments of the invention with concave and planar surfaces, respectively;

FIG. 3 is an exploded-perspective view of an in-grade lighting fixture that uses the lens illustrated in FIG. 1; and

FIG. 4 is a flow diagram of an embodiment of a method for manufacturing a slip-resistant apparatus that has a pattern of grit granules partially embedded in frit regions coupled to a lens.

### DETAILED DESCRIPTION OF THE INVENTION

A slip-resistant apparatus, in accordance with an embodiment of the invention, includes grit granules partially embedded in frit coupled to the surface of transparent plate. The grit granules increase the coefficient of friction for the plate to establish a slip-resistant surface that is substantially transparent.

Although embodiments of the invention are applicable to slip-resistant surfaces in general, several embodiments are particularly applicable to slip-resistant lenses for use in in-grade lighting fixtures and will be discussed within that context in greater detail, below. It is understood, however, that the embodiments are equally applicable to other surfaces.

Also, while several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

In one embodiment of the invention shown in FIG. 1, a transparent plate in the form of a lens 100 has a pattern of disk-shaped regions (“dots”) composed of grit partially embedded in previously melted frit ink 105 and distributed evenly over and coupled to a surface 110 of the lens 100, preferably over a planar surface, to form staggered rings of dots. In this embodiment, the frit ink (“frit”) 105 is preferably composed of powdered glass with an enamel carrier. An example of frit includes frit ink part number 20-8099 in 1326 medium offered by Ferro Corporation in Ohio, USA. Other colored or non-colored (clear) frit ink may be used, such as red, green, blue, or some other hue of the same.

The grit is preferably size #30 to #600 grit aluminum oxide (AlO₂), preferably #180 grit AlO₂, or other similar grit material such as ground quartz or fused silica. As used in this description, grit size refers to the U.S. Commercial Standard CS 271-65 sizing system for grit granules. The word “grit” itself refers to either a size, when used in combination with a number according to the CS 271-65 sizing system, or to a material such as AlO₂ quartz or silica, as appropriate. Preferably, each granule of grit has a rhombohedral shape with points extending above and below a frit surface 112 to enhance friction with the elastomeric sole and heel material of footwear, while resisting detachment and wear from the lens surface 110. Examples of AlO₂ grit include the ALODUR® line of fused aluminum oxide offered by Treibacher Schleifmittel AG of Austria. Although 180 grit AlO₂ is preferred, larger grit would tend to increase the static coefficient of friction as measured by a drafsled-type friction meter and smaller grit would tend to decrease the static coefficient of friction.

The lens 100 is preferably a transparent lens such as those used in light fixture, with one example being an in-grade light fixture. The lens 100 can be formed of many different materials with a suitable material being a borosilicate glass or soda lime glass. The lens can have many different shapes and sizes, with a suitable lens being circular and having a diameter and thickness of 10.26 and 1.27 cm, respectively, to provide transparency for use with industry-standard Par 20 lamp systems.

Each “dot” 105 can have a different size and shape, with a suitable dot having a diameter of approximately 0.38 cm. Many different numbers of dots 105 can be used and as shown, collectively form forty-five dots coupled to the surface 110. The powdered glass in the frit is preferably composed of glass having a melting point so that the frit's melting point is lower than that of the grit granules and lens material. This enables melting of the frit without melting the grit or lens material, so that the grit becomes at least partially embed into the frit 105 upon application of appropriate heat. When the frit 105 is allowed to cool, it hardens with the grit held in the frit.

Although the dots 105 are illustrated forming staggered rings, other geometric formations of dots 105 are possible, such as ovals, triangles, and squares or random formations. The ratio of dot area to unpatterned surface area may be increased to increase the overall coefficient of friction of the surface at the expense of transparency. Decreasing the ratio of grit region to untreated surface would decrease the overall coefficient of friction of the surface and increase transparency. Also, although the dots 105 are illustrated as circular regions, they may themselves form other patterns such as ovals, triangles, squares or random patterned regions.

In the present embodiment with frit ink part number 20-8099 in 1326 medium, the frit is semi-transparent with a tan coloration. Other frit inks may be used to impart other colorations, including red, green, blue colorations. Or, a clear frit ink may be used. In some embodiments according to the present invention, the frit and grit combination can be specifically formulated to change the color the light passing through the lens. For example, if green light were desired for emission from an in-grade lamp, the frit and grit can be formulated to change the white light form the lamp's internal light source to green as it passes through the lens. This allows for the desired light conversion while also provided the desired slip resistance.

In an alternative embodiment of the invention, the lens 100 forms a transparent or semi-transparent plate in a non-lamp system, with the dots 105 formed on the surface 100 to reduce the surface's coefficient of friction while allowing a view to an opposite side of the plate. Such a slip-resistant plate may form a portion of an elevated walkway surface, panel or other protective covering that may be subject to pedestrian traffic.

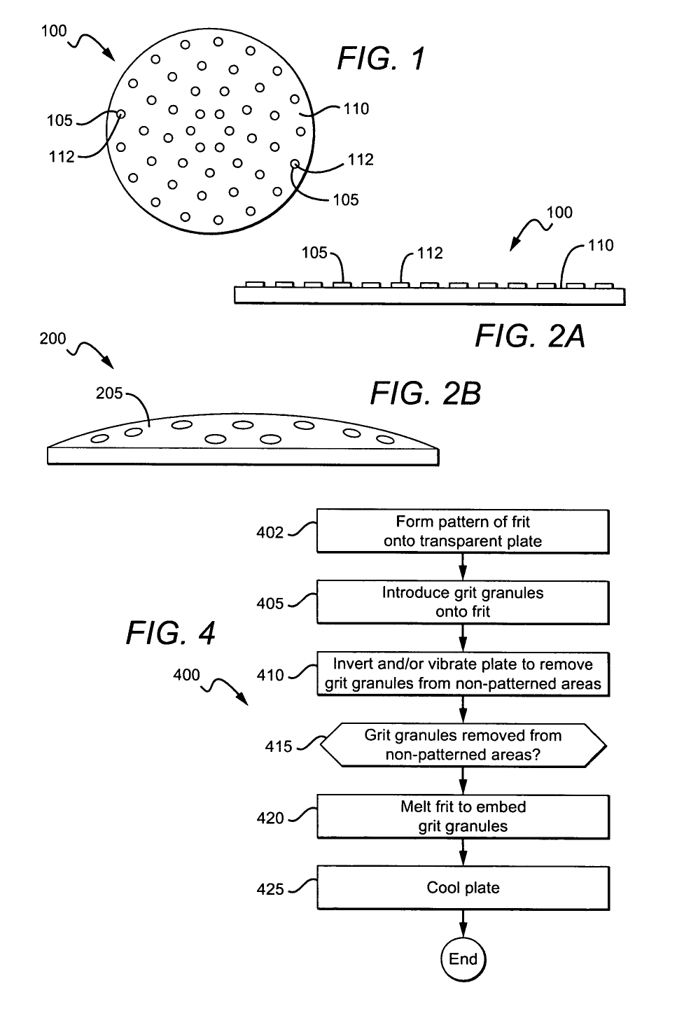

FIGS. 2A and 2B are side views illustrating two examples of lenses that have dots. In FIG. 2A, the dots 105 are formed on the planar surface 110 of FIG. 1, such as might be used in an in-ground lighting fixture. In FIG. 2B, the dots are formed on a convex surface 205 such as a dome lens also for use with in-ground lighting fixtures. Both lenses are rated for walkover or drive-over applications, with the dots providing increased coefficient of friction from what would otherwise exist without them.

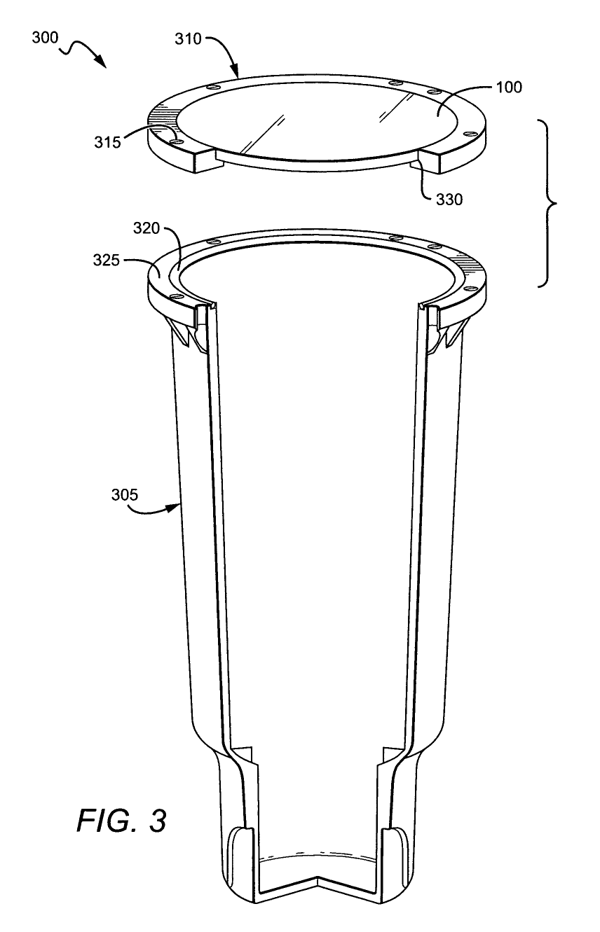

FIG. 3 is an exploded perspective view showing the lens illustrated in FIGS. 1 and 2A for use in an in-grade lighting fixture 300, although it is understood that the lens can be used in many other applications. The fixture includes a housing 305 made from a corrosion-free or corrosive resistant material that is suitable for the location in which the light fixture will be used, such as for in-grade applications, and is preferably formed from high-strength, bulk molding polyester. A faceplate 310 attaches to the housing 305 with one or more connectors, such as screws 315. An o-ring 320, such as a high temperature silicone o-ring, or other sealing mechanism is disposed between the faceplate 310 and an upper edge 325 of the housing 305 to provide a seal for the top of the fixture 300. The lens 100 is seated in a notched lens seat 330 spanning an inner perimeter of the faceplate 310.

FIG. 4 illustrates one embodiment of a method 400 for manufacturing the slip-resistant plates according to the present invention. The method can be used for forming plates made of many different materials and is particularly adapted to forming plates of borosilicate glass with a melting point of 799° C. In step 402, the pattern of the frit is formed onto the plate. Many different formation techniques can be used, with silk-screening being a suitable formation technique. Many different frits with many different powdered glass and enamels can be used, with a suitable frit being commercially available from Ferro Corporation under frit ink part number 20-8099 in 1326 medium. The frit can be formed in many different patterns with a suitable patter being circular regions that are themselves patterned into a series of staggered rings. The frit has a melting temperature lower than the lens material, such as in the range of 538-787° Celsius.

In step 405, the grit particles are introduced into the frit. Many different particles can be used, with a suitable particle being AlO₂ with a grit size of #180, which has a melting point of approximately 2000° C. The grit can be introduced using many different methods, with suitable methods being introduction by hand or by other mechanical means onto the patterned and non-pattered regions of the plate so that the grit loosely adheres to the frit.

In step 410, the grit that is not on the frit areas of the plate such as by inverting and/or vibrating the plate. In block 415, if the grit has been sufficiently removed from the non-frit portions, the plate moves on to the next step in the method 400. If not, it is returned to step 410 for further removal of the grit.

In step 420, the frit is melted by introducing the plate into a furnace preheated to approximately 730° C. The plate is then left in the furnace until the frit melt, and in one embodiment according to the present invention, the plate is left in the furnace to heat for approximately six minutes (block 420) to melt the frit.

In step 425, the plate is removed from the furnace and cooled to bring the plate to approximately ambient conditions resulting in the frit coupling to the lens surface. In one embodiment the plate can be cooled by exposing it to a relatively high velocity gas, such as air, that is directed at the plate for a period of approximately six minutes. If lower velocity of air is used, a slower cool down would occur. With such a method, approximately 30-50% of each grit granule is embedded in the surface of the frit and the frit is coupled to the surface of the lens so that the grit may engage the sole and heel materials of shoes to provide a slip-resistant surface.

While various implementations of the application have been described, it will be apparent to those of ordinary skill in the art that many more embodiments and implementations are possible that are within the scope of this invention.

1. A slip-resistant apparatus, comprising:
a transparent plate;
a plurality of frit regions coupled to a surface of said plate; and
a plurality of grit granules partially embedded in said plurality of frit regions;
wherein the coefficient of friction for said surface is increased.

2. The apparatus of claim 1, wherein said plate comprises a lens.

3. The apparatus of claim 1, wherein said plate comprises glass.

4. The apparatus of claim 3, wherein said glass comprises borosilicate glass.

5. The apparatus of claim 4, wherein said glass comprises soda lime glass.

6. The apparatus of claim 3, wherein said plurality of frit regions are distributed approximately evenly over said surface.

7. The apparatus of claim 1, wherein said frit regions have a lower melting point than said transparent plate.

8. The apparatus of claim 7, wherein each of said frit regions is approximately circular.

9. The apparatus of claim 1, wherein said plurality of grit granules comprises aluminum oxide.

10. The apparatus of claim 1, wherein said plurality of grit granules is selected from the group consisting of aluminum oxide, ground quartz and fused silica.

11. The apparatus of claim 1, wherein said surface is planar.

12. An in-grade lighting fixture apparatus, comprising:
a housing;
a lens coupled to one end of said housing, said lens having a surface;
a plurality of frit regions coupled to said surface; and
a plurality of grit granules partially embedded in said plurality of frit regions;
wherein said plurality of grit granules increases the coefficient of friction of said surface.

13. The apparatus of claim 12, wherein said plurality of frit regions are distributed evenly over said surface.

14. The apparatus of claim 12, wherein said surface is approximately planar.

15. The apparatus of claim 12, wherein said frit regions comprise colored pigments.

16. A method of manufacturing a slip-resistant plate, comprising:
forming a pattern of enamel regions on a surface of a transparent surface, said enamel regions having embedded frit;
introducing a plurality of grit granules onto said enamel regions;
melting said frit; and
cooling said frit;
wherein said remaining grit granules become partially embedded in and fixed to said frit to increase the coefficient of friction of the surface.

17. The method according to claim 16, further comprising vibrating said plate surface to remove excess grit granules not introduced to said enamel regions.

18. The method according to claim 16, further comprising inverting said plate surface to remove excess grit granules not introduced to said enamel regions.

19. The method according to claim 16, wherein said melting comprises heating said enamel regions in a furnace that is heated to approximately 730° C.

20. The method according to claim 16, wherein said frit is heated to approximately 730° C.

21. The method according to claim 16, wherein said cooling comprises blowing gas across said surface.
